(19) United States
(12) Patent Application Publication
(10) Pub. No.: US 2015/0343932 A1
(43) Pub. Date: Dec. 3, 2015

(54) CUSHION BODY FOR VEHICLE SEAT

(71) Applicant: SINDAI CO., LTD., Takahama-shi (JP)

(72) Inventor: Masayuki Hosoe, Takahama-shi (JP)

(21) Appl. No.: 14/714,793

(22) Filed: May 18, 2015

(30) Foreign Application Priority Data
Jun. 2, 2014 (JP) 2014-114299

(51) Int. Cl. B60N 2/70; B60N 2/64

(52) U.S. Cl. CPC B60N 2/7094; B60N 2/646

(57) ABSTRACT

A cushion body for a vehicle seat is configured including spring members each having a plurality of bent portions, a stretching-across member disposed in a manner stretching across between the spring members, and a coupling member coupling the stretching-across member and the spring member. The stretching-across member is stretched across between the spring members in a manner arranged at a position different from that of a bent portion of the spring member, and the coupling member is formed in a manner not including the bent portion of the spring member.

### BACKGROUND OF THE INVENTION

1. Field of the Invention

The present invention relates to a cushion body for a vehicle seat to be attached to a seat frame so as to receive a load of an occupant.

2. Description of the Related Art

A conventional cushion spring (cushion body for a vehicle seat) disclosed in JP2009-172025 A has been provided. According thereto, the cushion spring is to be attached to a seat plate frame of a vehicle seat, and includes a wire spring formed by folding a straight spring wire rod into substantially U-shapes and a coupling member installed additionally to the wire spring and fixed by clips.

Moreover, the coupling member is arranged in a manner connecting a tip corner portion and base corner portion of the wire spring(s), tip corner portions to each other, and/or base corner portions to each other.

However, in the above-described cushion body for a vehicle seat, there has been a tendency that, because of the arrangement in a manner connecting a tip corner portion and base corner portion of the wire spring(s), tip corner portions to each other, and/or base corner portions to each other, elastic deformation in the periphery of the wire spring including its bent part thereof is suppressed and the wire spring is excessively suppressed from sinking in to result in a hard-seated seat.

Also, because of the necessity for coupling at a plurality of points by metallic clips, the number of components has increased to increase the weight and there has been a great burden on an operator who attaches the clips. Further, there has been a problem that labor costs also increase because attaching clips to a wire spring is difficult to automate.

### SUMMARY OF THE INVENTION

The present invention has been made to solve the problems mentioned above, and it is an object of the present invention to provide a cushion body for a vehicle seat capable of, by securing surface rigidity to maintain seat hardness and then dispersing a load to a plurality of spring members to impart appropriate sinking-in, improving discomfort due to hard seating, and suppressing an increase in the number of components, weight, and labor costs to reduce the burden on an operator.

In a first aspect of the present invention, which includes at least two spring members each formed of a long metallic member and having a plurality of bent portions, a stretching-across member made of metal, formed in a rod shape, and disposed in a manner stretching across between the spring members, and a synthetic resin-made coupling member coupling the stretching-across member and the spring member, the stretching-across member is stretched across between the spring members in a manner arranged at a position different from that of the bent portion of the spring member, and the coupling member is formed in a manner not including the bent portion of the spring member.

According thereto, the coupling member is disposed in a manner not coupling a neighboring bent portion, which therefore no longer diminishes the spring member in spring function. Therefore, discomfort due to hard seating can be improved by securing surface rigidity to maintain seat hardness and then dispersing a load to the plurality of spring members to impart appropriate sinking-in. Further, because manufacturing using an injection molding machine is enabled, an increase in the number of components, weight, and labor costs can be suppressed to reduce the burden on an operator.

In a second aspect of the present invention, the spring member is formed in a manner bent into a square wave shape, and a pair of spring members are disposed into a mirror image relationship to constitute an assembly, and the assemblies are arranged in a plurality of lines in a right-left direction.

According thereto, in a spring member formed in a manner bent into a square wave shape, if a rod-shaped stretching-across member is stretched across, a state of coupling the bent portions of an identical or different spring members may occur, but in that case, deformation of each spring member is limited to impair the spring function. Due to the above-described configuration, because of being coupled at a position off the bent portion, a spring member formed in a manner bent into a square wave shape, recent adoption implementation of which has increased, can be made preferable particularly in the case of coupling with a stretching-across member by a resin member.

In a third aspect of the present invention, on the spring member, the stretching-across member is disposed at least double so as to be substantially perpendicular thereto, the coupling member has a coupling portion coupling the stretching-across member and the spring member in an including manner and a tubular portion extending from the coupling portion in a manner including the stretching-across member and along the stretching-across member, and a connecting member that connects the tubular portions of the coupling members disposed on an identical spring member to each other is disposed.

It is thereby prevented that a crossing part between the spring member and the stretching-across member reaches a non-perpendicular state when a force to move in a front-rear direction is applied to the stretching-across member, which can prevent whitening of the resin member and the occurrence of a crack.

As in a fourth aspect of the present invention, if the stretching-across member is configured so as to be arranged on an upper side of the spring member and have stopper portions formed in a downwardly bending manner at both end portions of the stretching-across member, the stopper portion can prevent the spring member and the stretching-across member from contacting to cause coming-off when a strong force is applied to the stretching-across member.

### BRIEF DESCRIPTION OF THE DRAWINGS

FIG. 1 is a perspective view showing a state in which a cushion body for a vehicle seat of an embodiment of the present invention is fitted.

FIG. 2 is a plan view of the cushion body for a vehicle seat of the same embodiment.

FIG. 3 is a side view of the cushion body for a vehicle seat of the same embodiment.

FIG. 4 is a rear view of the cushion body for a vehicle seat of the same embodiment.

FIG. 5 is a perspective view of the cushion body for a vehicle seat of the same embodiment when viewed from above.

FIG. 6 is a perspective view of the cushion body for a vehicle seat of the same embodiment when viewed from below.

FIG. 7 is a partially enlarged plan view of first U-shaped portions and first inverted U-shaped portions.

### DETAILED DESCRIPTION OF THE INVENTION

A first embodiment of a cushion body for a vehicle seat of the present invention will be described based on drawings. In the following description, the arrows in the respective drawings show directions in a state of being installed in a vehicle, and F means front, B means back, R means right, L means left, U means up, and D means down.

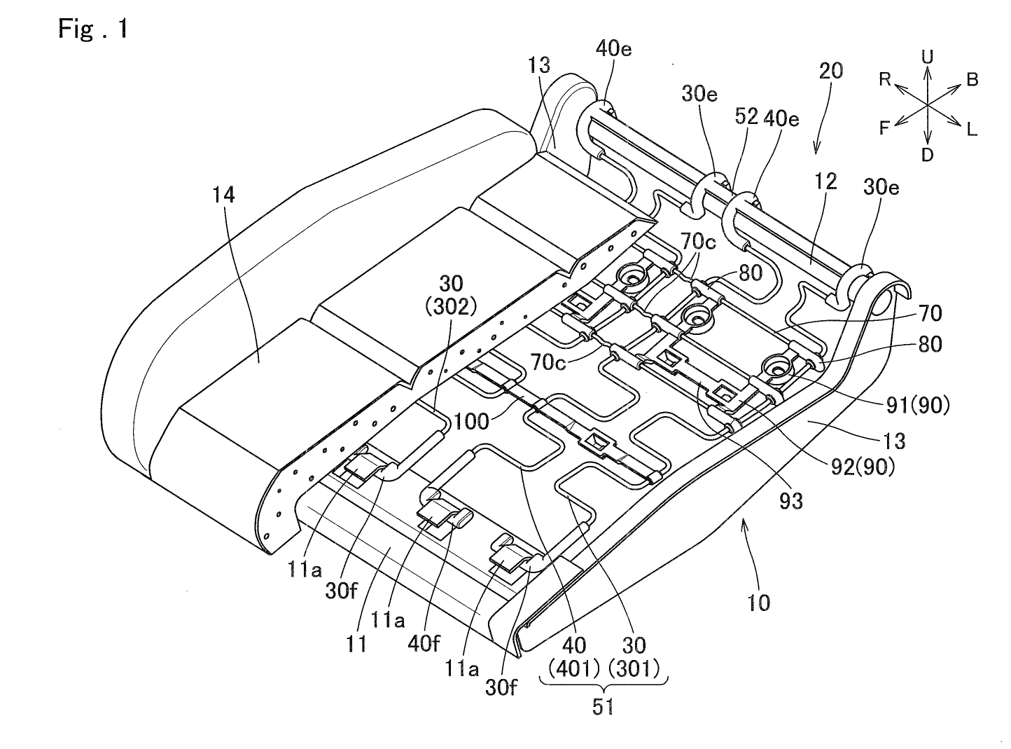

The cushion body 20 for a vehicle seat is, as shown in FIG. 1, attached in a manner stretching across between front and rear ends of a seat frame 10.

The seat frame 10 has a plate member 11 located at a front side, a tubular bar 12 located at a rear side, and side frames 13 and 13 that couple left-hand end portions of the plate member 11 and the bar 12 to each other and right-hand end portions of the same to each other, and is formed in a rectangular frame shape in a plan view. With a cushion pad 14 attached on an upper side of the seat frame 10, the cushion body 20 for a vehicle seat is arranged on a lower surface of the cushion pad 14 in a manner supporting the pad 14.

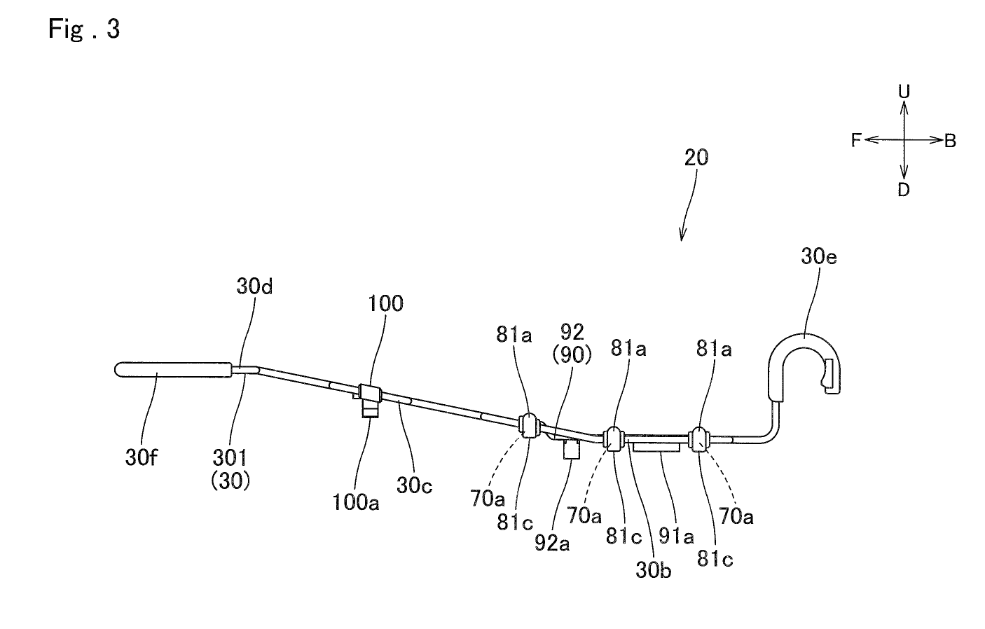

The cushion body 20 for a vehicle seat includes, as shown in FIG. 1 to FIG. 7, spring members 30 and 40, stretching-across members 70, and resin-made coupling members 80 that couple the stretching-across members 70 and the spring members 30, 40.

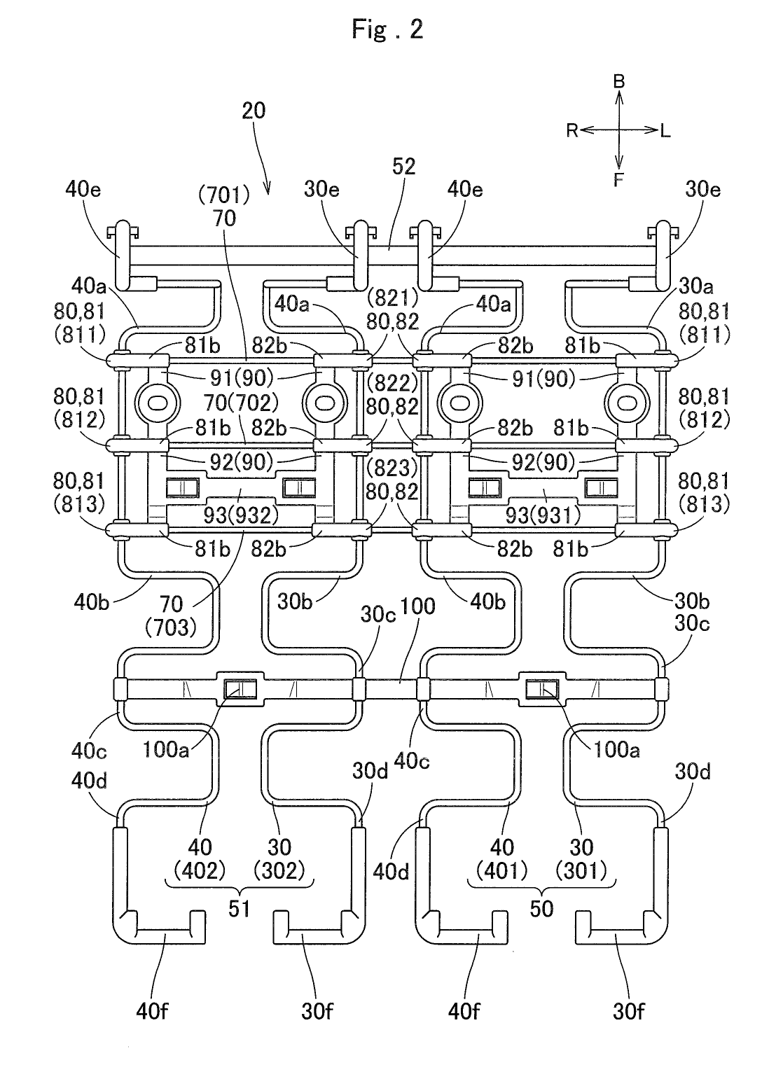

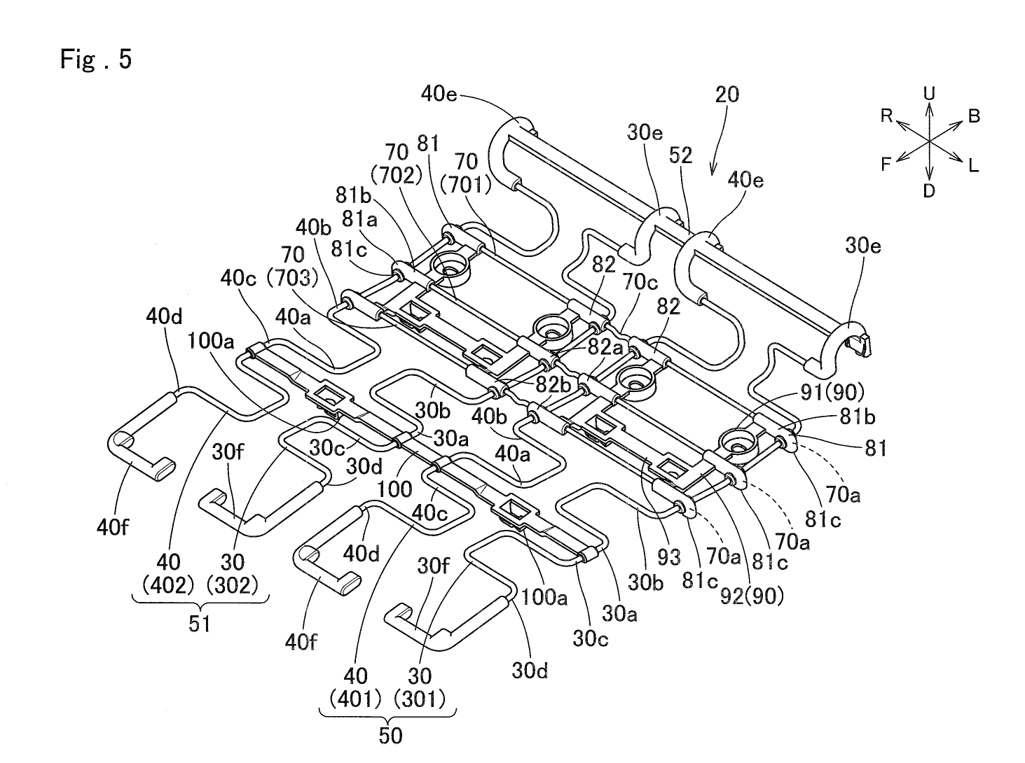

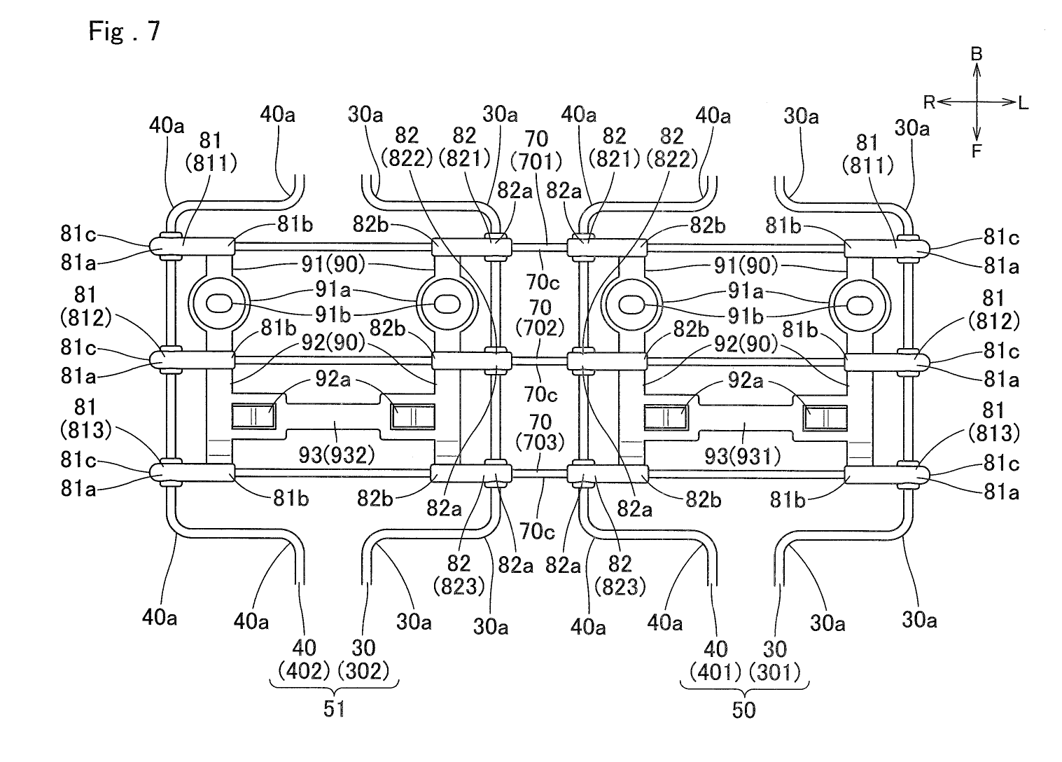

The spring members 30 (when differentiated, the left-hand spring member 30 is referred to as a spring member 301, and the right-hand spring member 30 is referred to as a spring member 302) are each formed of a long metallic member, formed in a manner bent into a square wave shape, and has a plurality of bent portions 30a, as shown in FIG. 2, FIG. 5, and FIG. 7.

The spring member 30 has a first U-shaped portion 30b, a second U-shaped portion 30c, and a third U-shaped portion 30d which are opened at their left side in order from the back.

The spring members 40 (when differentiated, the left-hand spring member 40 is referred to as a spring member 401, and the right-hand spring member 40 is referred to as a spring member 402) are each formed of a long metallic member, formed in a manner bent into a square wave shape, and has a plurality of bent portions 40a, as shown in FIG. 2, FIG. 5, and FIG. 7.

The spring member 40 has a first inverted U-shaped portion 40b, a second inverted U-shaped portion 40c, and a third inverted U-shaped portion 40d which are opened at their right side in order from the back.

The spring member 301 and the spring member 401 are arranged into a mirror image relationship to constitute a left assembly 50 (corresponding to an assembly in the claims), and the spring member 302 and the spring member 402 are arranged into a mirror image relationship to constitute a right assembly 51 (corresponding to an assembly in the claims). Further, the left assembly 50 and the right assembly 51 are arranged in two lines in the right-left direction.

At rear end portions of the spring members 30 and 40, latching portions 30e and 40e that are formed in substantially inverted J-shapes in a side view and can be latched with the bar 12 are disposed, respectively. The latching portions 30e and 40e are covered at their outside with a thermoplastic synthetic resin.

On the latching portions 30e and 40e, a rear coupling member 52 formed of a thermoplastic synthetic resin in a shape corresponding to a contour shape of the bar 12 is disposed. The rear coupling member 52 is stretched across between upper end portions of the latching portions 30e and 40e.

At a front end portion of the third U-shaped portion 30d, an attaching portion 30f formed in a substantially inverted L-shape in a manner including a part of the spring member 30 is disposed, and at a front end portion of the third inverted U-shaped portion 40d, an attaching portion 40f formed in a substantially L-shape in a manner including a part of the spring member 40 is disposed.

The attaching portions 30f and 40f are formed of a thermoplastic synthetic resin, and are, as shown in FIG. 1, formed so as to be attachable to hooks 11a disposed on the plate member 11 by hooking, respectively.

The part composed of the first U-shaped portions 30b, the first inverted U-shaped portions 40b, and the stretching-across members 70 serves as a part corresponding to a part of the cushion pad 14 on which occupant's hips are placed, called a hip point

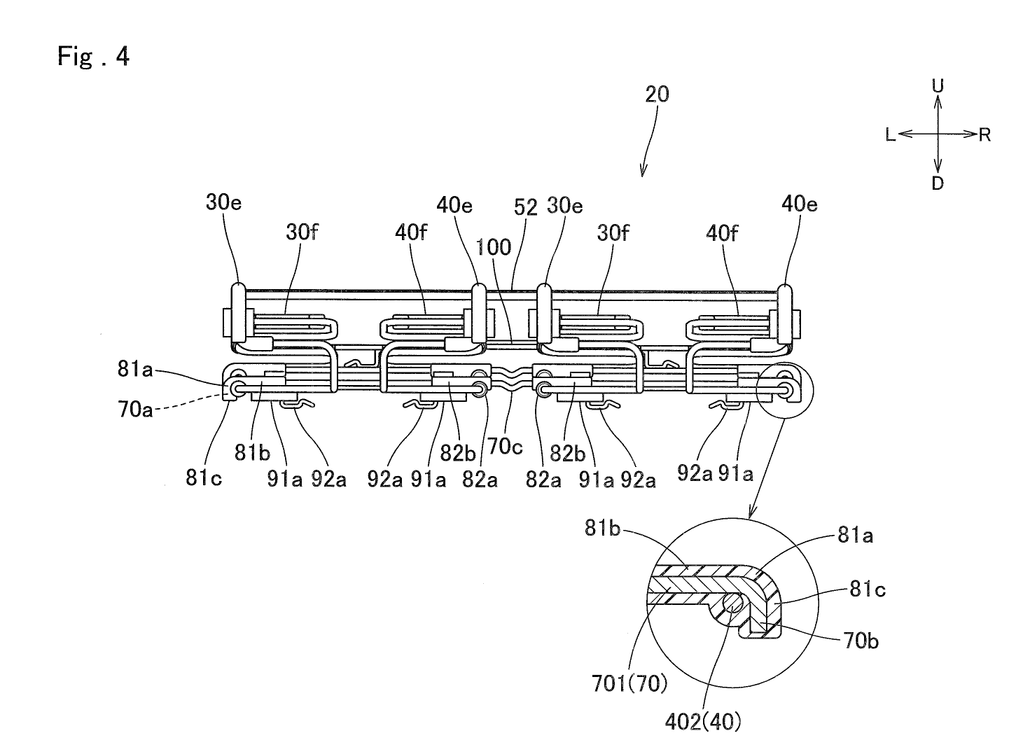

The stretching-across members 70 (when differentiated, these are referred to as a stretching-across member 701, a stretching-across member 702, and a stretching-across member 703 in order from the back side) are, as shown in FIG. 1 to FIG. 7, made of metal and formed in rod shapes, and have stopper portions 70a formed at left end portions of the stretching-across members 70 in a downwardly bending manner, respectively, and stopper portions 70b formed at right end portions of the stretching-across members 70 in a downwardly bent manner, respectively. Although only the stopper portion 70b is shown in the circle of FIG. 4, the stopper portion 70a is also the same.

In a central portion in the right-left direction of the stretching-across member 70 as well as a part to be between the left assembly portion 50 and the right assembly portion 51, i.e., between the spring member 401 and the spring member 302, a positioning portion 70c formed in a manner bent with its angled part down is disposed.

The stretching-across member 70 is, in the first U-shaped portion 30b and the first inverted U-shaped portion 40b, arranged on an upper side of the spring member 30, 40 as well as at a position different from that of the bent portion 30a, 40a of the spring member 30, 40, and is stretched across between the spring members 301 and 402 arranged at the right and left end portions with the stopper portion 70a arranged so as to be on a left side of the spring member 301 and the stopper portion 70b arranged so as to be on a right side of the spring member 402.

The coupling members 80 are, as shown in FIG. 1 to FIG. 7, formed of a thermoplastic synthetic resin, and composed of outer coupling members 81 that couple on an outer side in the right-left direction of the cushion body 20 for a vehicle seat and inner coupling members 82 that couple on an inner side.

The outer coupling members 81 (when differentiated, these are referred to as an outer coupling member 811, an outer coupling member 812, and an outer coupling member 813 in order from the back side) have coupling portions 81a, tubular portions 81b, and longitudinal tubular portions 81c, as shown in FIG. 4, FIG. 5, etc.

The coupling portion 81a, in and around an intersection part between the stretching-across member 70 and the spring member 301, 402, couple the stretching-across member 70 and the spring member 301, 402 in an including manner. The coupling member 81a is, as shown in FIG. 7, disposed in a manner not including the bent portion 30a, 40a of the spring member 301, 402.

The tubular portion 81b is formed in a manner including the stretching-across member 70, and in the outer coupling member 81 disposed on the spring member 301, in a manner extending from the coupling portion 81a toward the right side along the stretching-across member 70, and in the outer coupling member 81 disposed on the spring member 402, extending from the coupling portion 81a toward the left side along the stretching-across member 70.

The longitudinal tubular portion 81c extends from the coupling portion 81a toward the downside in a manner including the stopper portion 70a or the stopper portion 70b.

The inner coupling members 82 (when differentiated, these are referred to as an inner coupling member 821, an inner coupling member 822, and an inner coupling member 823 in order from the back side) have coupling portions 82a and tubular portions 82b, as shown in FIG. 4, FIG. 5, etc.

The coupling member 82a, in and around an intersection part between the stretching-across member 70 and the spring member 302, 401, couple the stretching-across member 70 and the spring member 302, 401 in an including manner. The coupling member 82a is, as shown in FIG. 7, disposed in a manner not including the bent portion 30a, 40a of the spring member 302, 401.

The tubular portion 82b is formed in a manner including the stretching-across member 70, and in the inner coupling member 82 disposed on the spring member 401, in a manner extending from the coupling portion 82a toward the left side along the stretching-across member 70, and in the inner coupling member 82 disposed on the spring member 301, extending from the coupling portion 82a toward the right side along the stretching-across member 70.

Connecting members 90 are, as shown in FIG. 1 to FIG. 7, formed of a thermoplastic synthetic resin in band shapes, and have rear connecting portions 91 that connect the tubular portions 81b of the outer coupling member 811 and the outer coupling member 812 to each other and the tubular portions 82b of the inner coupling member 821 and the inner coupling member 822 to each other and front connecting portions 92 that connect the tubular portions 81b of the outer coupling member 812 and the outer coupling member 813 to each other and the tubular portions 82b of the inner coupling member 822 and the inner coupling member 823 to each other.

In a central portion in the front-rear direction of the rear connecting portion 91, a dish portion 91a opened upward is provided in a manner having a circular bottom wall and a side wall extending upward from an outer peripheral edge portion of the bottom wall, and in the bottom wall of the dish portion 91a, a through-hole 91b is formed to make a clip insertable therethrough.

In a central portion in the front-rear direction of the front connecting portion 92, a hook 92a on which electrical wiring is hooked is disposed.

Transverse connecting members 93 (when differentiated, the left-hand transverse connecting member 93 is referred to as a transverse connecting member 931, and the right-hand transverse connecting member 93 is referred to as a transverse connecting member 932) are, as shown in FIG. 7, formed of a thermoplastic synthetic resin in band shapes. The transverse connecting member 931 is disposed in a manner connecting the front connecting portions 92 disposed on the spring member 301 and the spring member 401 to each other, and the transverse connecting member 932 is disposed in a manner connecting the front connecting portions 92 disposed on the spring member 302 and the spring member 402 to each other.

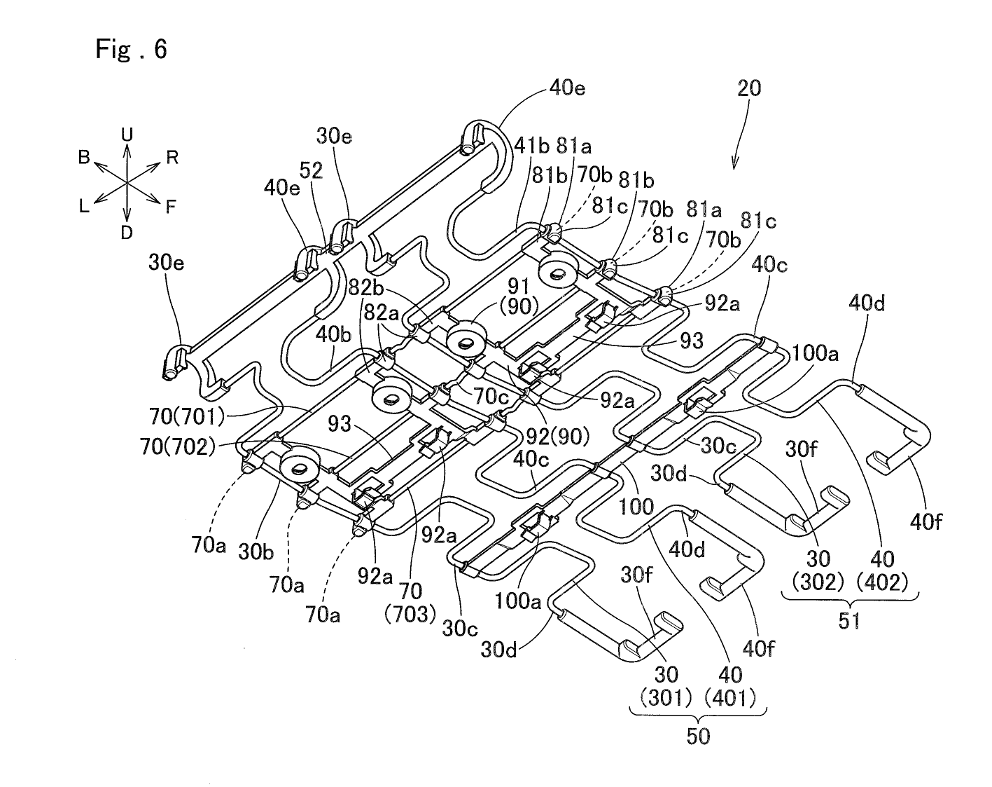

A front coupling member 100 is, as shown in FIG. 2 and FIG. 6, formed of a thermoplastic synthetic resin, and stretched across the second U-shaped portion 30c of the spring member 30 and the second inverted U-shaped portion 40c of the spring member 40 along the right-left direction so as to pass therethrough to thereby couple the spring member 301 and the spring member 401, the spring member 401 and the spring member 302, and the spring member 302 and the spring member 402.

In the front coupling portion 100, between the second U-shaped portion 30c of the spring member 301 and the second inverted U-shaped portion 40c of the spring member 401 and between the second U-shaped portion 30c of the spring member 302 and the second inverted U-shaped portion 40c of the spring member 402, hooks 100a on which electrical wiring is hooked are disposed, respectively.

For molding the latching portions 30e and 40e, the attaching portions 30f and 40f, the rear coupling member 52, the coupling members 80, the connecting members 90, and the front coupling member 100 that are formed of a thermoplastic synthetic resin, by performing injection molding with the spring members 30 and 40 and the stretching-across members 70 set in an injection mold, the latching portions 30e and 40e, the attaching portions 30f and 40f, the rear coupling member 52, the coupling members 80, the connecting members 90, and the front coupling member 100 are integrated in a manner including the spring member 30, 40 and the stretching-across member 70, and the spring members 30 and 40 and the stretching-across members 70 are coupled.

A cushion body 20 for a vehicle seat having the above-described configuration includes spring members 30 and 40 each formed of a long metallic member and having a plurality of bent portions 30a and 40a, a stretching-across member 70 made of metal, formed in a rod shape, and disposed in a manner stretching across between the spring members 30 and 40, and a synthetic resin-made coupling member 80 coupling the stretching-across member 70 and the spring member 30, 40, in which the stretching-across member 70 is stretched across between the spring members 30 and 40 in a manner arranged at a position different from that of the bent portion 30a, 40a of the spring member 30, 40, and the coupling member 80 is formed in a manner not including the bent portion 30a, 40a of the spring member 30, 40.

According thereto, the coupling member 80 is disposed in a manner not coupling a neighboring bent portion 30a, 40a, which therefore no longer diminishes the spring member 30, 40 in spring function. Therefore, discomfort due to hard seating can be improved by securing surface rigidity to maintain seat hardness and then dispersing a load to the plurality of spring members 30 and 40 to impart appropriate sinking-in. Further, because manufacturing using an injection molding machine is enabled, an increase in the number of components, weight, and labor costs can be suppressed to reduce the burden on an operator.

Also, the spring member 30, 40 is formed in a manner bent into a square wave shape, and a pair of spring members 30 and 40 are disposed into a mirror image relationship to constitute a left assembly 50 or a right assembly 51, and the left assembly 50 and the right assembly 51 are arranged in a plurality of lines in a right-left direction.

According thereto, in a spring member 30, 40 formed in a manner bent into a square wave shape, if a rod-shaped stretching-across member 70 is stretched across, a state of coupling the bent portions 30a, 40a of an identical or different spring members 30, 40 may occur, but in that case, deformation of each spring member 30, 40 is limited to impair the spring function. Due to the above-described configuration, because of being coupled at a position off the bent portion 30a, 40a, a spring member 30, 40 formed in a manner bent into a square wave shape, recent adoption implementation of which has increased, can be made preferable particularly in the case of coupling with a stretching-across member 70 by a resin member.

Also, on the spring member 30, 40, three stretching-across members are disposed so as to be substantially perpendicular thereto, the coupling member 80 has a coupling portion 81a or a coupling portion 82a coupling the stretching-across member 70 and the spring member 30, 40 in an including manner and a tubular portion 81b or a tubular portion 82b extending from the coupling portion 81a or the coupling portion 82a in a manner including the stretching-across member 70 and along the stretching-across member 70, and a connecting member 90 that connects the tubular portions 81b or the tubular portions 82b of the coupling members 80 disposed on an identical spring member 30, 40 to each other is disposed.

It is thereby prevented that a crossing part between the spring member 30, 40 and the stretching-across member 70 reaches a non-perpendicular state when a force to move in a front-rear direction is applied to the stretching-across member 70, which can prevent whitening of the resin member and the occurrence of a crack.

Also, if the stretching-across member 70 is configured so as to be arranged on an upper side of the spring member 30, 40 and have stopper portions 70a and 70b formed in a downwardly bending manner at both end portions of the stretching-across member 70, the stopper portion 70a, 70b can prevent the spring member 30, 40 and the stretching-across member 70 from contacting to cause coming-off when a strong force is applied to the stretching-across member 70.

Also, because the transverse connecting member 931 connects the front connecting portions 92 disposed on the spring member 301 and the spring member 401 to each other and the transverse connecting member 932 connects the front connecting portions 92 disposed on the spring member 302 and the spring member 402 to each other, a central part of the left assembly 50 and the right assembly 51 can be suppressed from sinking in to secure surface rigidity of an area including a hip point.

The cushion body 20 for a vehicle seat of the present invention is not limited to the above-described configuration. That is, various design changes etc., are possible without departing from the gist of the present invention.

For example, as the stretching-out member 70, a single, two, or four or more stretching out members can also be disposed.

Also, it is also possible to dispose the stretching-across member 70 between the second U-shaped portion 30c and the second inverted U-shaped portion 40c and between the third U-shaped portion 30d and the third inverted U-shaped portion 40d.

The stretching-across member 70, which is arranged along the right-left direction, can be disposed in a manner inclined with respect to the front-rear direction or the right-left direction.

Also, the cushion body 20 for a vehicle seat, which is applied to a seat on which hips are placed for which the cushion pad 14 is disposed, can also be applied to a seat on a backrest side.

What is claimed is:

1. A cushion body for a vehicle seat including at least two spring members each formed of a long metallic member and having a plurality of bent portions, a stretching-across member made of metal, formed in a rod shape, and disposed in a manner stretching across between the spring members, and a synthetic resin-made coupling member coupling the stretching-across member and the spring member, wherein
the stretching-across member is stretched across between the spring members in a manner arranged at a position different from that of the bent portion of the spring member, and the coupling member is formed in a manner not including the bent portion of the spring member.

2. The cushion body for a vehicle seat according to claim 1, wherein the spring member is formed in a manner bent into a square wave shape, and a pair of the spring members are disposed into a mirror image relationship to constitute an assembly, and the assemblies are arranged in a plurality of lines in a right-left direction.

3. The cushion body for a vehicle seat according to claim 2, wherein on the spring member, the stretching-across member is disposed at least double so as to be substantially perpendicular thereto,
the coupling member has a coupling portion coupling the stretching-across member and the spring member in an including manner and a tubular portion extending from the coupling portion in a manner including the stretching-across member and along the stretching-across member, and
a connecting member that connects the tubular portions of the coupling members disposed on an identical spring member to each other is disposed.

4. The cushion body for a vehicle seat according to claim 3, wherein the stretching-across member is arranged on an upper side of the spring member, and both end portions of the stretching-across member have stopper portions formed in a downwardly bending manner.
